(19) United States
(12) Patent Application Publication
(10) Pub. No.: US 2025/0151082 A1
(43) Pub. Date: May 8, 2025

(54) EVENT-BASED SEARCH SPACE SET GROUP (SSSG) SWITCHING AND PHYSICAL DOWNLINK CONTROL CHANNEL (PDCCH) SKIPPING

(71) Applicant: QUALCOMM Incorporated, San Diego, CA (US)

(72) Inventors: Ahmed ELSHAFIE, San Diego, CA (US); Huilin XU, Temecula, CA (US); Diana MAAMARI, San Diego, CA (US); Peter GAAL, San Diego, CA (US)

(21) Appl. No.: 18/502,686

(22) Filed: Nov. 6, 2023

(51) Int. Cl. H04W 72/232; H04L 1/1812; H04W 72/12; H04W 72/512

(52) U.S. Cl. CPC H04W 72/232; H04L 1/1812; H04W 72/12; H04W 72/512

(57) ABSTRACT

Certain aspects of the present disclosure provide a method for wireless communications at a user equipment (UE). The UE may monitor search space sets (SSSs) associated with a first SSS group (SSSG) for at least one control channel. The UE may switch from the first SSSG to a second SSSG based on an occurrence of an event. The UE may monitor SSSs associated with a second SSSG for the at least one control channel.

### BACKGROUND

### Field of the Disclosure

Aspects of the present disclosure relate to wireless communications, and more particularly, to techniques for event-based search space set group (SSSG) switching and physical downlink control channel (PDCCH) skipping.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes monitoring search space sets (SSSs) associated with a first SSS group (SSSG) for at least one control channel; switching from the first SSSG to a second SSSG based on an occurrence of an event; and monitoring SSSs associated with a second SSSG for the at least one control channel.

Another aspect provides a method for wireless communications at a network entity. The method includes transmitting a configuration of a plurality of search space set groups (SSSGs) comprising at least a first SSSG and a second SSSG to a user equipment (UE); determining to switch control channel monitoring of the UE from the first SSSG to the second SSSG based on an occurrence of an event; and transmitting an indication to the UE to switch from the first SSSG to the second SSSG, in accordance with the determination.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 and FIG. 6 depict example use cases for physical downlink control channel (PDCCH) skipping.

FIG. 7 and FIG. 8 depict example use cases for search space set group (SSSG) switching.

FIG. 9 and FIG. 10 depict example use cases for SSSG switching with PDCCH skipping.

FIG. 11 depicts example behaviors indicated to a UE by a scheduling downlink control information (DCI).

FIG. 12 depicts example values for a duration for PDCCH skipping.

FIG. 13 depicts a call flow diagram illustrating example communication among a UE and a network entity.

FIG. 14 depicts example event-based SSSG switching from a first SSSG to a second SSSG.

FIG. 15 depicts example scheduling request (SR) occasions.

FIG. 16 depicts a method for wireless communications at a UE.

FIG. 17 depicts a method for wireless communications at a network entity.

FIG. 18 and FIG. 19 depict example communications devices.

### DETAILED DESCRIPTION

Aspects of the present disclosure provide apparatuses, methods, processing systems, and computer-readable mediums for managing search space set group (SSSG) switching and physical downlink control channel (PDCCH) skipping.

In new radio (NR) systems, several user equipment (UE) power saving methods have been specified to provide improvements to power consumption for the UEs in a connected mode. Some of these techniques may include bandwidth part (BWP) adaptation framework (e.g., cross-slot scheduling, etc.), wakeup signal for connected mode-discontinuous reception (C-DRX), etc.

In a connected mode of a UE, one of the main contributors to the power consumption is a period and frequency of monitoring PDCCH to read scheduled grants on uplink and downlink. For example, the PDCCH may be decoded by the UE in every slot based on information associated with: one or more control resource sets (CORESETs) (e.g., which may indicate to the UE where to search for PDCCH candidates and may also include a time-frequency region where the UE monitors for a PDCCH transmission), and one or more SSSGs (e.g., which may indicate to the UE how to search for the PDCCH candidates in SSs or SSSs of the one or more SSSGs and are configured per BWP).

Lately, some additional methods have been specified to further reduce UE power consumption in PDCCH monitoring within an active BWP and enabling UE measurements relaxation for radio link monitoring (RLM). For example, a PDCCH monitoring adaptation method may provide enhancements for the support of new use cases (e.g., such as extended reality (XR) services that require much shorter packet inter-arrival times, and where PDCCH-only monitoring can dominate the UE power consumption). The PDCCH monitoring adaptation method may include PDCCH skipping and SSSG switching to reduce the UE power consumption.

In some cases, based on a PDCCH monitoring adaptation indication in a downlink control information (DCI), the UE may be triggered to skip the PDCCH monitoring during a specific period from a next slot after the indication is received. After this duration, the UE may be required to monitor PDCCHs again. Similarly, the UE may also be indicated via the DCI to switch to a specific SSSG and stop PDCCH monitoring in any other SSSG in order to perform reduced PDCCH monitoring.

Instead of signal-based/DCI-based SSSG switching and PDCCH skipping, aspects of the present disclosure provide techniques for event-based dynamic switching between different SSSGs and/or skipping of PDCCH monitoring for different durations, which may allow a UE to have more power saving than is possible by the signal-based/DCI-based SSSG switching and PDCCH skipping.

For example, the UE may be configured with the different SSSGs (e.g., which may include different SSSs), and the UE may dynamically or autonomously switch from one SSSG to another SSSG (e.g., to perform reduced PDCCH monitoring) based on content of one or more reports (e.g., such as a buffer status report, a delay status report, a statistical delay report, and an energy status report), presence of certain traffic (e.g., such as XR traffic, low latency traffic), etc. The described techniques may allow the UE to have more power saving, since the UE is able to dynamically and autonomously perform many power saving actions (e.g., such as the SSSG switching, the PDCCH skipping) based on a detection of different events, rather than waiting for any signals from the gNB to perform these power saving actions.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

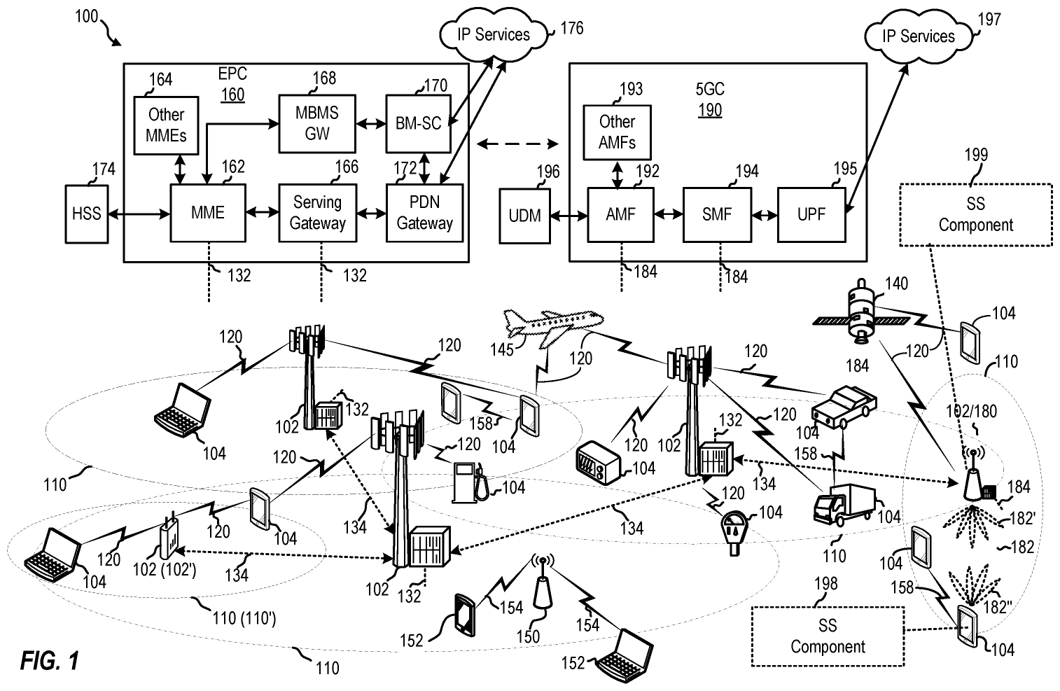

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

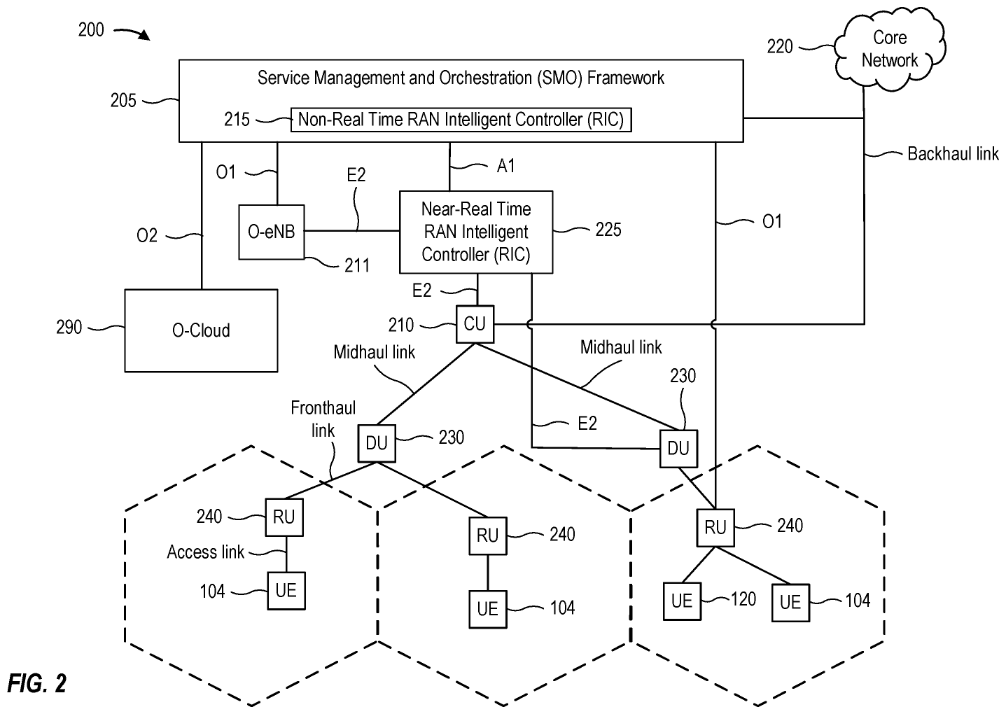

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (Rus), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHZ-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mm Wave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

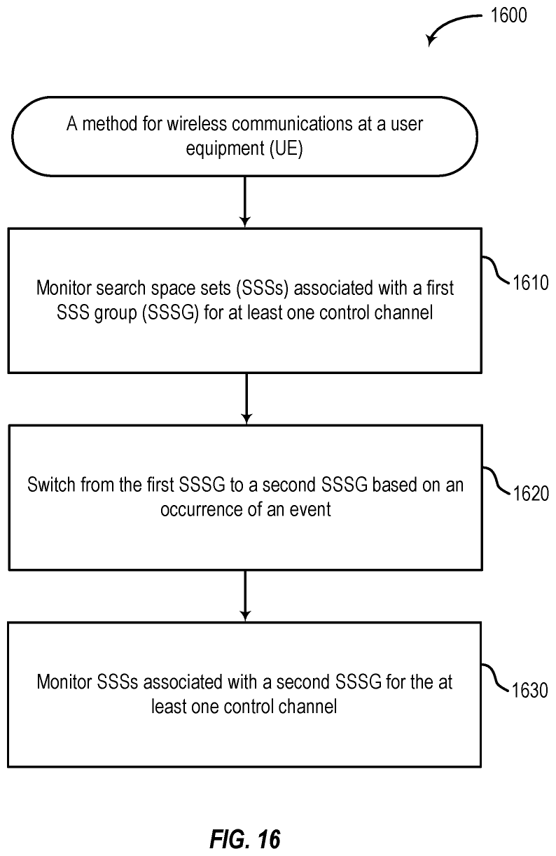

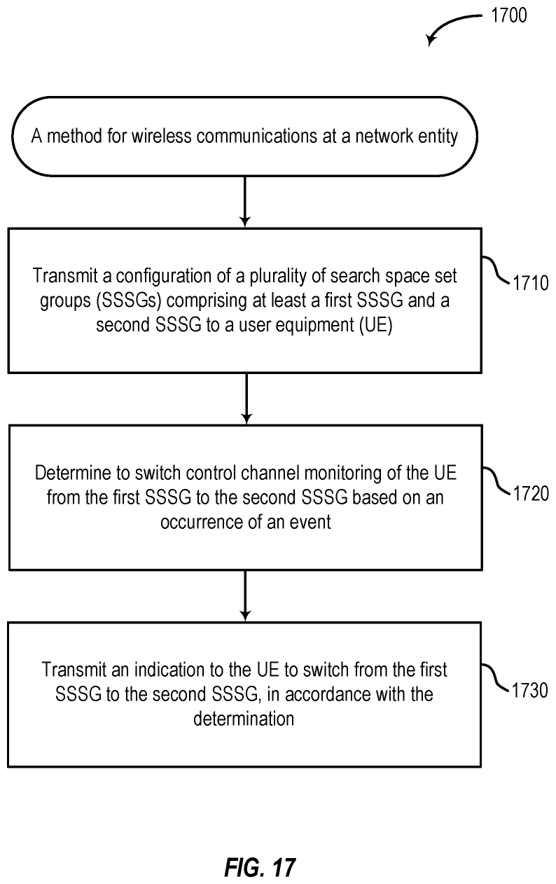

Wireless communication network 100 further includes search space (SS) component 198, which may be configured to perform method 1600 of FIG. 16. Wireless communication network 100 further includes SS component 199, which may be configured to perform method 1700 of FIG. 17.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (Cus) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

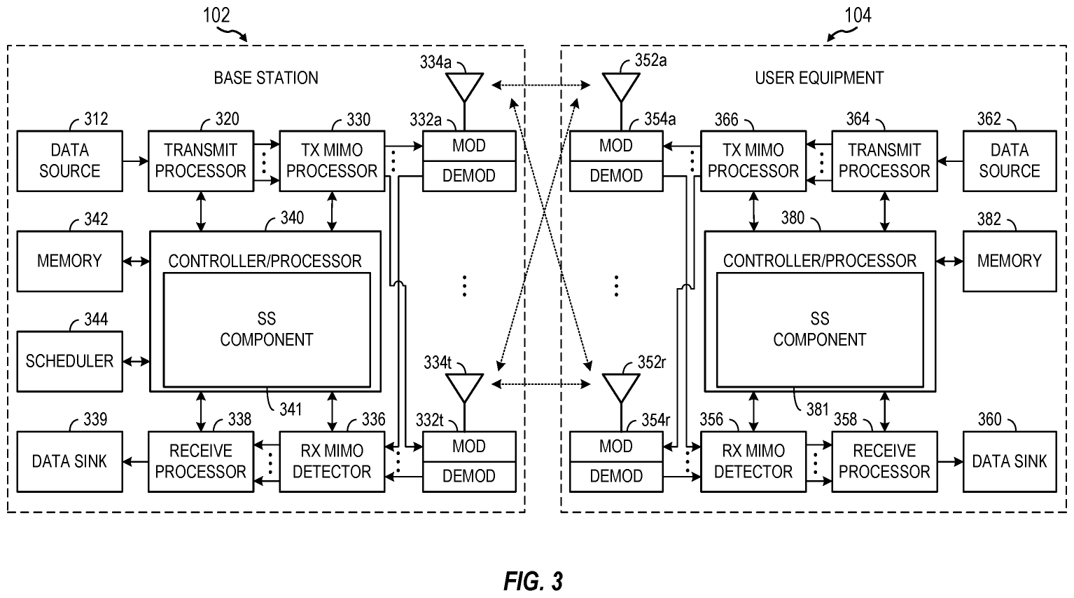

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SS component 341, which may be representative of SS component 199 of FIG. 1. Notably, while depicted as an aspect of controller/processor 340, SS component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SS component 381, which may be representative of SS component 198 of FIG. 1. Notably, while depicted as an aspect of controller/processor 380, SS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

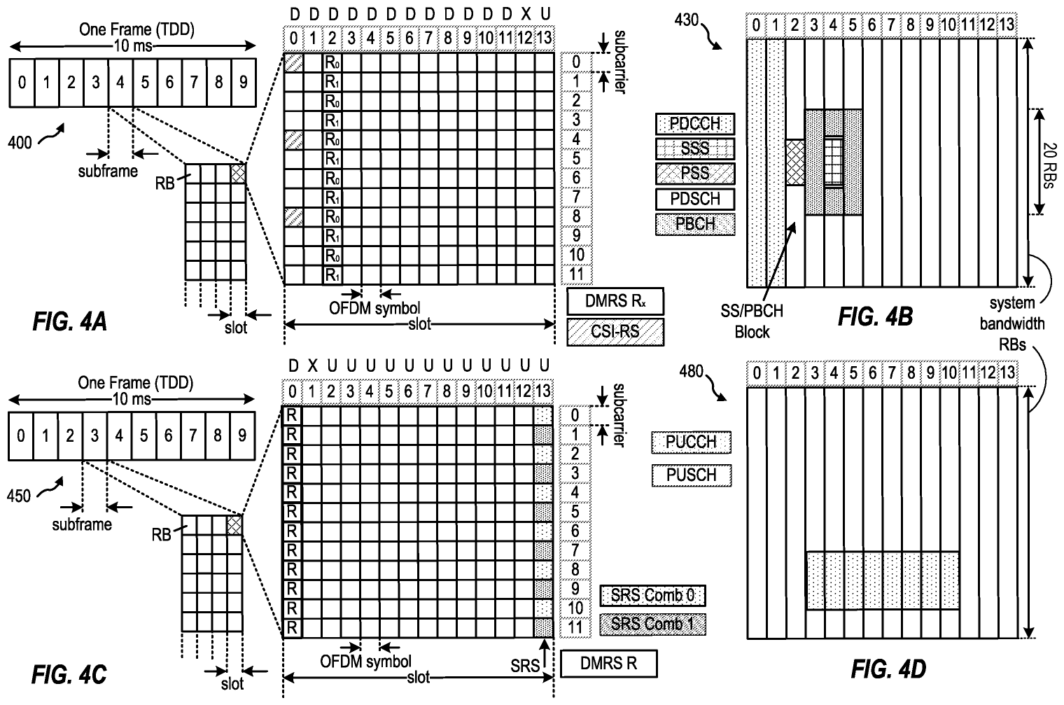

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHZ-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Example Signals and Search Space Set (SSS)

Downlink signals may include data signals conveying information content, control signals conveying downlink control information (DCI), reference signals (RSs), etc. A gNodeB (gNB) transmits data information or the DCI through respective physical downlink shared channels (PDSCHs) or physical downlink control channels (PDCCHs).

Uplink signals may include data signals conveying information content, control signals conveying uplink control information (UCI), a random access preamble enabling a user equipment (UE) to perform random access, etc. The UE transmits data information or the UCI through respective physical uplink shared channels (PUSCHs) or physical uplink control channels (PUCCHs).

A UE monitors multiple candidate locations for respective potential PDCCH receptions to decode one or more DCI formats in a slot. A DCI format may include cyclic redundancy check (CRC) bits in order for the UE to confirm a correct detection of the DCI format. A DCI format type is identified by a radio network temporary identifier (RNTI) that scrambles the CRC bits. For a DCI format scheduling a PDSCH or a PUSCH to a single UE, the RNTI can be a cell RNTI (C-RNTI) and serve as a UE identifier. For a DCI format scheduling a PDSCH conveying system information (SI), the RNTI can be a SI-RNTI. For a DCI format scheduling a PDSCH providing a random access response (RAR), the RNTI can be a RA-RNTI. For a DCI format providing transmit power control (TPC) commands to a group of UEs, the RNTI can be a TPC-RNTI. Each RNTI type may be configured to the UE through a higher layer signaling such as a radio resource control (RRC) signaling. A DCI format scheduling a PDSCH transmission to the UE is referred to as downlink DCI format or downlink assignment while a DCI format scheduling a PUSCH transmission from the UE is referred to as uplink DCI format or uplink grant.

A PDCCH transmission can be within a set of physical resource blocks (PRBs). The gNB can configure the UE with one or more sets of PRB sets, also referred to as control resource sets (CORESETs), for PDCCH receptions. The PDCCH transmission can be in control channel elements (CCEs) of a CORESET. The UE determines the CCEs for the PDCCH reception based on a search space set (SSS).

For example, in order for the UE to decode a PDCCH (DCI), the UE has to determine an exact value for a location (e.g., a CCE index), a structure (e.g., an aggregation level, interleaving etc) and a scrambling code (e.g., RNTI) etc. But such information is not informed to the UE beforehand, and in most cases, those values may change dynamically. The only thing known to the UE is the information about a certain range that possibly carries the PDCCH (DCI). The UE knows about the information about this certain range by a predefined rule or signaling message. Within this range, the UE may try to decode the PDCCH/DCI using different types of parameters (e.g., the CCE Index, the aggregation level, the RNTI). This way of decoding is called blind decoding. A predefined region in which the UE may perform the blind decoding is called an SSS. The SSS may be a set of control channel elements at a different aggregation level. The SSS may indicate how many candidates are there to decode at different aggregation levels. There is a mapping between a CORESET and an SSS. The different aggregation levels may be there to mitigate the situation when the UE is under a bad coverage.

The SSS may be a common SSS or a UE-specific SSS. The UE-specific SSS is dedicated for each specific UE and informed to the UE via an RRC signaling message. The common SSS is the specific SSS that every the UE need to search for the signals for every UE (e.g., a PDCCH for a system information block (SIB)) or signaling message that is applied to every UE before a dedicated channel is established for a specific UE (e.g., the PDCCH used during a random access channel (RACH) process).

For each downlink bandwidth part (BWP) configured to the UE in a serving cell, the UE may be provided with a number of SSSs where for each SSS from a number SSSs, the UE is provided: an SSS index, an association between the SSS index and a CORESET index, a PDCCH monitoring periodicity, a PDCCH monitoring offset, a PDCCH monitoring pattern within a slot, a number of PDCCH candidates, and/or an indication that the SSS is either the common SSS or the UE-specific SSS.

### Example Physical Downlink Control Channel (PDCCH) Monitoring Adaptation

In new radio (NR), a user equipment (UE) monitors one or more physical downlink control channels (PDCCHs) at PDCCH monitoring occasions based on configured search space sets (SSSs) for each serving cell provided to the UE by a gNodeB (gNB).

In a communication system, power saving is one of the most important issue and this is especially more important for the UE which has a limited amount of power source (e.g., a battery). This issue has become more important in the NR since it has relatively widely experienced that the UE may tend to drain power more quickly when the UE is in 5G than in other legacy technology.

Currently, several features have been implemented that may have an impact on the power saving of the UE. For example, the UE usually has to monitor the PDCCHs at ever slot unless the UE is in a discontinuous reception (DRX) sleep mode. However, in some cases, the UE may be configured to stop PDCCH monitoring for a certain duration or a number of consecutive slots to save power.

In some cases, a downlink control information (DCI) may be used to specify this periodic PDCCH monitoring to the UE. For example, based on a corresponding PDCCH monitoring adaptation indication in the DCI, the UE may be triggered to skip the PDCCH monitoring during a specific period from a next slot after the indication is received. After this duration, the UE may be required to monitor the PDCCHs again.

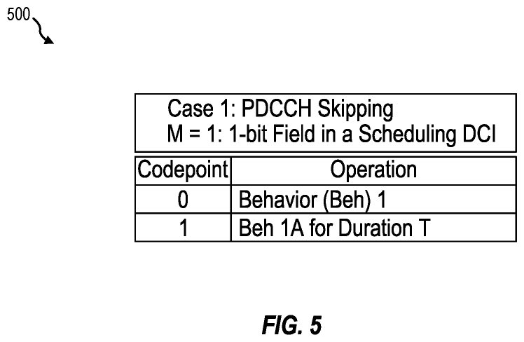

As illustrated in a diagram 500 of FIG. 5, one or more bits (or codepoints) in a scheduling DCI (e.g., of one-bit field) may indicate a duration T to the UE for which the UE may skip PDCCH monitoring. For example, a bit 0 in the DCI indicates that the PDCCH monitoring may not be skipped. A bit 1 in the DCI indicates that the PDCCH monitoring may be skipped for a duration provided by a first PDCCH skipping duration value (i.e., duration T).

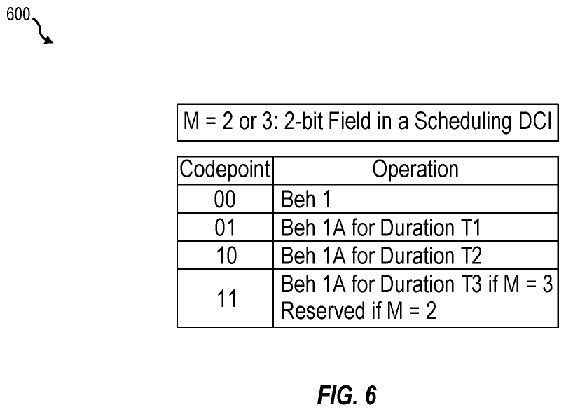

As illustrated in a diagram 600 of FIG. 6, two or more bits in a scheduling DCI (e.g., of two-bit field) may indicate to the UE one of different durations T1, T2, T3 for which the UE can skip PDCCH monitoring. For example, bits 00 in the DCI indicates that the PDCCH monitoring may not be skipped. Bits 01 in the DCI indicates that the PDCCH monitoring may be skipped for a duration provided by a first PDCCH skipping duration value (i.e., duration T1). Bits 10 in the DCI indicates that the PDCCH monitoring may be skipped for a duration provided by a second PDCCH skipping duration value (i.e., duration T2). Bits 11 in the DCI indicates that the PDCCH monitoring may be skipped for a duration provided by a third PDCCH skipping duration value (i.e., duration T3). If the set of PDCCH skipping durations only includes two values, then the value ‘11’ is reserved.

### Example Search Space Set Group (SSSG) Switching

In new radio (NR), a search space (SS) or a search space set (SSS) may refer to a particular area in a downlink resource grid where a physical downlink control channel (PDCCH) may be carried. A user equipment (UE) may perform blind decoding throughout the SS areas attempting to find PDCCH data (e.g., a downlink control information (DCI)). The UE may monitor PDCCH occasions, and switch from one SSS to another SSS by receiving a corresponding radio resource control (RRC) configuration. If a change to a different SSS is deemed to be necessary (e.g., change from an SSS with a higher density of PDCCH monitoring occasions to another SSS with a lower density of PDCCH monitoring occasions), the UE may have to receive the appropriate configuration (e.g., through RRC signaling) first and then switch to the different SSS.

For the purpose of power saving in occasions where data traffic pattern may change dynamically, there is a need to define techniques for the UE to dynamically and/or implicitly (e.g., without a need to receive new/updated SSS configuration) switch between different SSSs and/or different SSS groups (SSSGs). For example, the UE may be configured with different SSSGs which includes different SSs or SSSs in each SSSG, then the UE may dynamically (e.g., based on gNodeB (gNB) indication) and/or implicitly (e.g., based on an event) switch between different SSSGs.

In some cases, an active SS adaptation may include SSSG switching in which the UE may be configured to switch between two different types of PDCCH monitoring (e.g., sparse and frequent PDCCH monitoring occasions). In some cases, the SSSG switching may be implemented by other mechanisms, such as an explicit indication, an implicit indication, an implicit condition, and/or by a timer.

In some cases, the explicit switching of two SSSGs may be achieved via a detection of a specific DCI. For example, the UE may be provided up to three group indexes corresponding to SSSGs for PDCCH monitoring on an active downlink bandwidth part (BWP) of a serving cell. Additionally, as noted above, the UE may also be provided a set of PDCCH skipping durations. For that, DCI formats can include a PDCCH monitoring adaptation field of one bit or two bits.

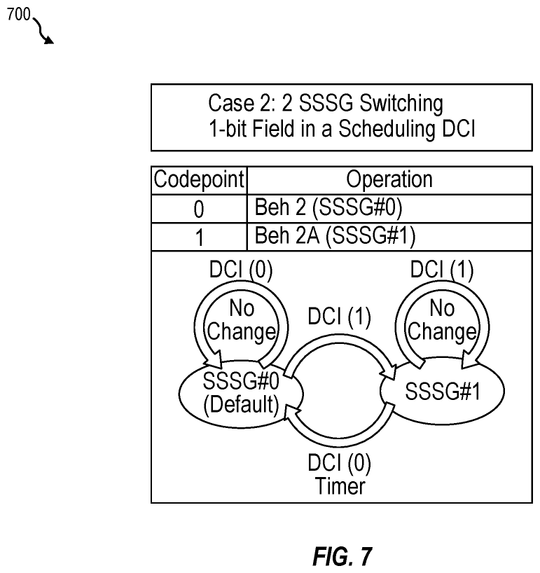

As illustrated in a diagram 700 of FIG. 7, a bit (or codepoint) 0 in a DCI indicates a UE to switch to an SSSG with a group index 0, i.e., a start of PDCCH monitoring in the SSSG with the index 0 and stop of the PDCCH monitoring in an SSSG with other group indexes. A bit 1 in the DCI indicates the UE to switch to an SSSG with a group index 1, i.e., a start of PDCCH monitoring in the SSSG with the index 1 and stop of the PDCCH monitoring in an SSSG with other group indexes.

In some cases, the UE may also initiate a configured SS switch timer. For example, the UE may start the SS switch timer, and upon expiration of the SS switch timer, the UE may switch to monitor the SSSG with the index 0 and stop monitoring the SSSG with the index 1. That is, when the UE monitors a PDCCH according to the SSSG with the index 1, and the SS switch timer expires (i.e., the SS switch timer value reaches zero), the UE starts monitoring the PDCCH according to the SSSG with the index 0 (e.g., a default SSSG) after an application delay.

In some cases, at a first slot after switching to the SSSG with the index 1, the UE sets the SS switch timer. The SS switch timer may be reset after a slot that the UE detects a DCI (e.g., having a DCI format with a cyclic redundancy check (CRC) scrambled by a cell-radio network temporary identifier (C-RNTI)/configured scheduling (CS)-RNTI/modulation and coding scheme (MCS)-C-RNTI (e.g., a unicast PDCCH)). Otherwise, a duration of the SS switch timer may be decreased by one after each slot.

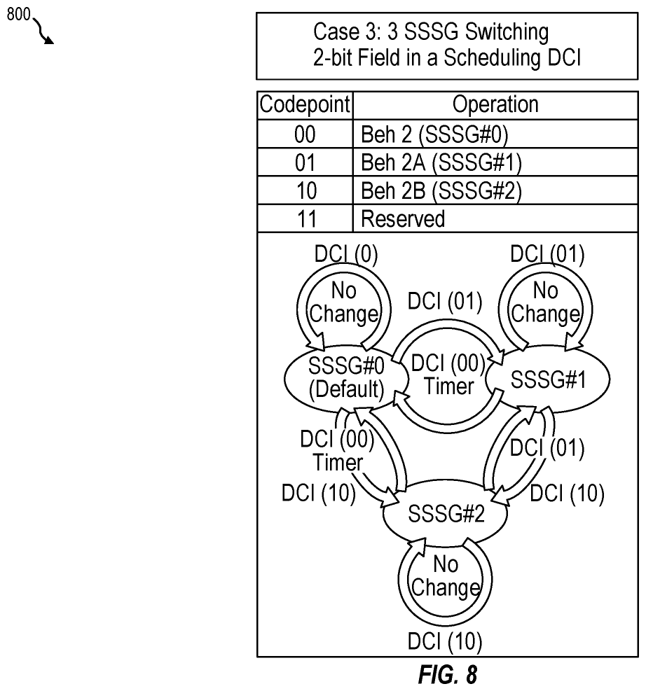

As illustrated in a diagram 800 of FIG. 8, bits 00 in a DCI indicates a UE to switch to an SSSG with a group index 0, i.e., a start of PDCCH monitoring in the SSSG with the index 0 and stop of the PDCCH monitoring in an SSSG with other group indexes. Bits 01 in the DCI indicates the UE to switch to an SSSG with a group index 1, i.e., a start of PDCCH monitoring in the SSSG with the index 1 and stop of the PDCCH monitoring in an SSSG with other group indexes. The UE may also initiate a configured SS switch timer. Bits 10 in the DCI indicates the UE to switch to an SSSG with a group index 2, i.e., a start of PDCCH monitoring in the SSSG with the index 2 and stop of the PDCCH monitoring in an SSSG with other group indexes. The UE may also initiate a configured SS switch timer. Bits 11 in the DCI indicates reserved.

In some cases, SSSG switching is combined with a set of PDCCH skipping durations. In such cases, two SSSGs can be configured and a PDCCH monitoring adaptation field consists of two bits.

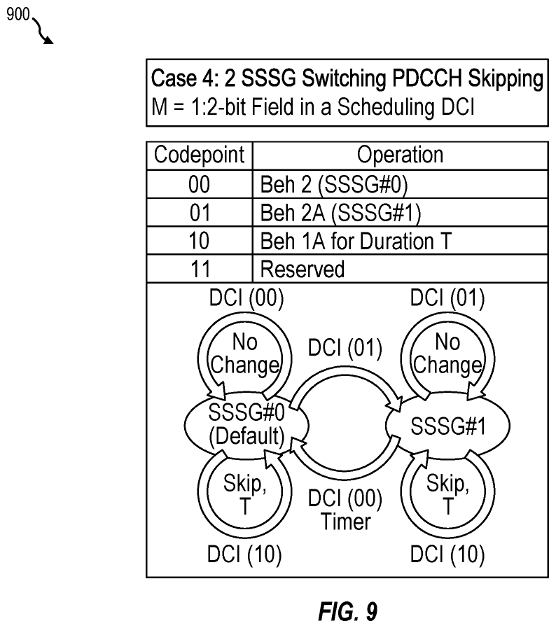

As illustrated in a diagram 900 of FIG. 9, bits 00 in a DCI indicates a UE to switch to an SSSG with a group index 0, i.e., a start of PDCCH monitoring in the SSSG with the index 0 and stop of PDCCH monitoring in an SSSG with a group index 1. Bits 01 in the DCI indicates the UE to switch to the SSSG with the group index 1, i.e., a start of PDCCH monitoring in the SSSG with the index 1 and stop of PDCCH monitoring in the SSSG with the group index 0. The UE may also initiate a configured SS switch timer. Bits 10 in the DCI indicates the UE to skip PDCCH monitoring for a duration provided by a PDCCH skipping duration value (e.g., T duration). Bits 11 in the DCI indicates reserved.

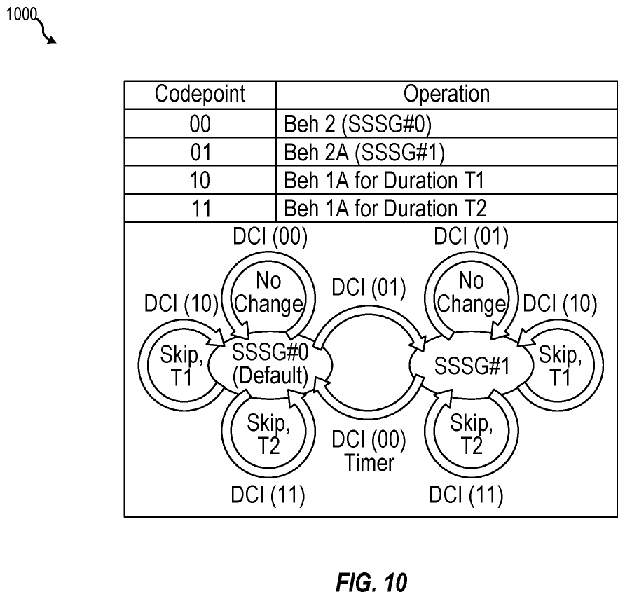

As illustrated in a diagram 1000 of FIG. 10, bits 00 in a DCI indicates a UE to switch to an SSSG with a group index 0, i.e., a start of PDCCH monitoring in the SSSG with the index 0 and stop of PDCCH monitoring in an SSSG with a group index 1. Bits 01 in the DCI indicates the UE to switch to the SSSG with the group index 1, i.e., a start of PDCCH monitoring in the SSSG with the index 1 and stop of PDCCH monitoring in the SSSG with the group index 0. The UE may also initiate a configured SS switch timer. Bits 10 in the DCI indicates the UE to skip PDCCH monitoring for a duration provided by a first PDCCH skipping duration value (e.g., T1 duration). Bits 11 in the DCI indicates skip PDCCH monitoring for a duration provided by a second PDCCH skipping duration value (e.g., T2 duration).

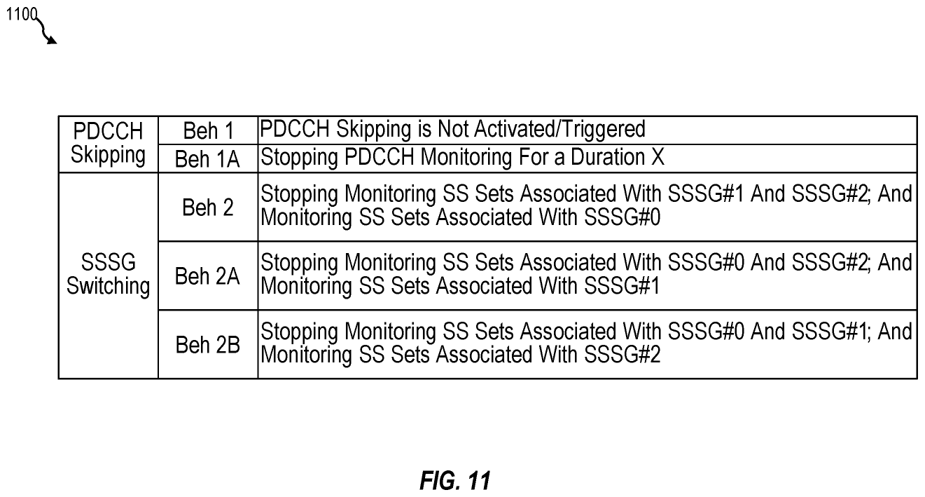

As discussed above and illustrated in a diagram 1100 of FIG. 11, a gNB may indicate different behaviors (e.g., related to PDCCH skipping and SSSG switching) to a UE using a scheduling DCI. For example, the UE may be indicated one of the following behaviors via the DCI: a) behavior 1 (i.e., the PDCCH skipping is not activated/triggered), behavior 1A (i.e., stop the PDCCH monitoring for a duration X), behavior 2 (i.e., stop monitoring SSSs associated with an SSSG with a group index 1 (SSSG #1) and an SSSG with a group index 2 (SSSG #2), and monitor SSSs associated with an SSSG with a group index 0 (SSSG #0)), behavior 2A (i.e., stop monitoring SSSs associated with SSSG #0 and SSSG #2, and monitor SS sets associated with SSSG #1), and behavior 2B (i.e., stopping monitoring SSSs associated with SSSG #0 and SSSG #1, and monitor SSSs associated with SSSG #2).

In some cases, one of the above behaviors may be mapped to a codepoint of an indication field in the scheduling DCI. In some cases, the PDCCH skipping and the SSSG switching may be applied at least for type3 common SS (CSS) and UE-specific SS (USS). Other CSSs may always be monitored by the UE, regardless of the SSSG switching and the PDCCH skipping.

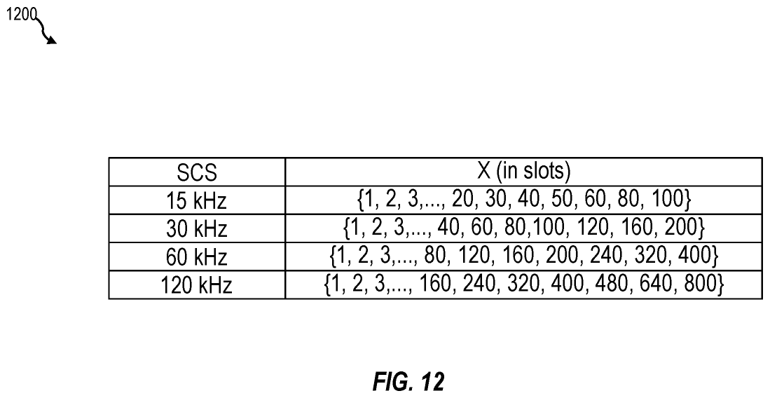

In some cases, for the behavior 1A discussed above, the UE may be provided with a value of the duration X from M configured values. A maximum value of the Mis three. Example values of X (e.g., in slots) for different subcarrier spacings (SCSs) are illustrated in a table 1200 of FIG. 12. In some cases, the duration X may be per BWP. In some cases, the example values illustrated in the table 1200 can also be configured for the SS switch timer.

### Aspects Related To Event-Based Search Space Set Group (SSSG) Switching and/or Physical Downlink Control Channel (PDCCH) Skipping

As noted above, search space set group (SSSG) switching and/or physical downlink control channel (PDCCH) skipping may be generally performed by a user equipment (UE) based on an indication via a downlink control information (DCI). Aspects of the present disclosure provide apparatuses, methods, processing systems, and computer-readable mediums for event-based dynamic switching between different SSSGs and/or skipping of PDCCH monitoring for different durations.

For example, the UE may be configured with different SSSGs (e.g., which may include different SSSs), and the UE may dynamically or autonomously switch from one SSSG to another SSSG based on content of one or more reports (e.g., such as a buffer status report, a delay status report, a statistical delay report, and an energy status report), presence of certain traffic (e.g., such as extended reality (XR) traffic, low latency traffic), etc.

Particular aspects of the subject matter described in this disclosure can be implemented to realize one or more of the following potential advantages. In some examples, the described techniques may allow the UE to have more power saving, since the UE is able to dynamically and autonomously perform many actions (such as the SSSG switching, the PDCCH skipping) to reduce its workload.

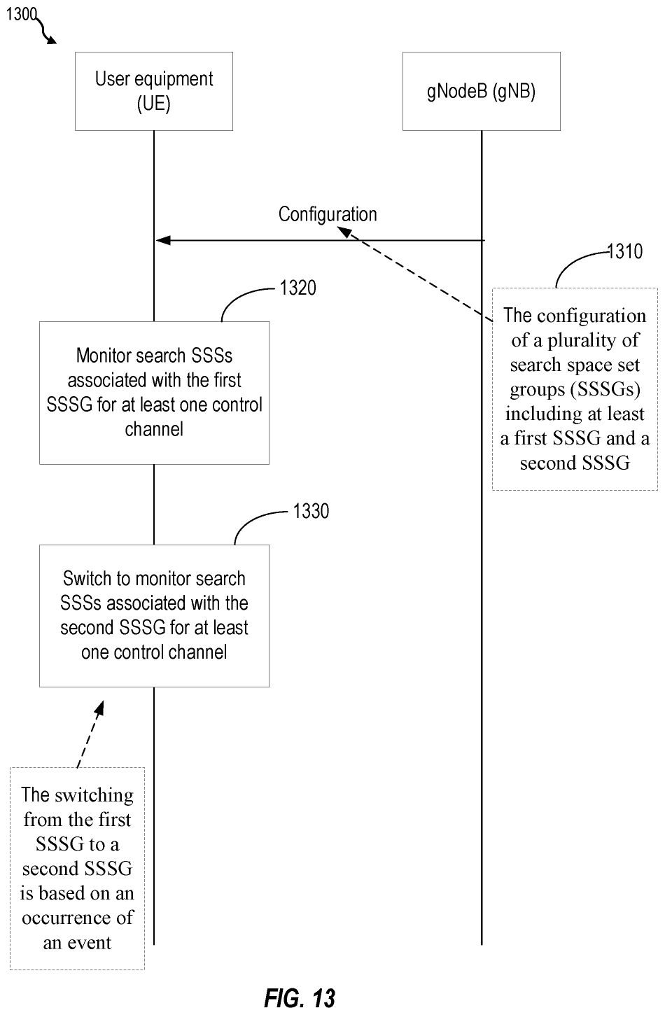

The techniques proposed herein for managing the event-based SSSG switch and the PDCCH skipping may be understood with reference to FIG. 13-FIG. 19.

FIG. 13 depicts a call flow diagram 1300 illustrating example communication among a UE and a network entity (e.g., a gNB) for managing event-based SSSG switch and PDCCH skipping. The UE shown in FIG. 13 may be an example of the UE 104 depicted and described with respect to FIG. 1 and FIG. 3. The gNB depicted in FIG. 13 may be an example of the BS 102 depicted and described with respect to FIG. 1 and FIG. 3, or the disaggregated BS depicted and described with respect to FIG. 2.

As indicated at 1310, the gNB transmits a configuration of a plurality of SSSGs to the UE. The plurality of SSSGs may include a first SSSG, a second SSSG, a third SSSG, etc.

In certain aspects, the configuration may indicate same or different thresholds for different reports. For example, the configuration may indicate a first set of thresholds for one or more features in a buffer status report. The one or more features in the buffer status report may include information corresponding to an amount of data available for transmission in an uplink buffer of the UE.

In another example, the configuration may indicate a second set of thresholds for one or more features in a delay status report. The one or more features in the delay status report may include information corresponding to a remaining packet delay budget, a packet wait time, etc. The remaining packet delay budget and the packet wait time may be associated with a same or a different value of a threshold.

In another example, the configuration may indicate a third set of thresholds for one or more features in a statistical delay report.

In another example, the configuration may indicate a fourth set of thresholds for one or more features in an energy status report. The one or more features in the energy status report may include information corresponding to an energy level profile of the UE, a charging rate of the UE, a discharging rate of the UE, etc. The energy level profile of the UE, the charging rate of the UE, and the discharging rate of the UE may be associated with a same or different value of a threshold.

As indicated at 1320, the UE monitors SSSs associated with the first SSSG for at least one control channel from the gNB. The control channels may correspond to PDCCHs transmitted from the gNB.

As indicated at 1330, the UE switches from the first SSSG to the second SSSG based on an occurrence of an event, and then monitors SSSs associated with the second SSSG for the at least one control channel from the gNB.

In certain aspects, the event may correspond to detecting values exceeding one or more thresholds of the first set of thresholds associated with the buffer status report. For example, the UE may determine that the values associated with the one or more features of the buffer status report may have exceeded a certain buffer threshold of the first set of thresholds. In another example, the gNB may determine that the values associated with the one or more features of the buffer status report may have exceeded the certain buffer threshold. The gNB may send the determined information to the UE.

In certain aspects, the event may correspond to detecting values exceeding one or more thresholds of the second set of thresholds associated with the delay status report. For example, the UE may determine that the values associated with the one or more features of the delay status report may have exceeded a certain delay threshold of the second set of thresholds. In another example, the gNB may determine that the values associated with the one or more features of the delay status report may have exceeded the certain delay threshold. The gNB may send the determined information to the UE.

In certain aspects, the event may correspond to detecting values exceeding one or more thresholds of the third set of thresholds associated with the statistical delay report. For example, the UE may determine that the values associated with the one or more features of the statistical status report may have exceeded a certain statistical delay threshold of the third set of thresholds. In another example, the gNB may determine that the values associated with the one or more features of the statistical status report may have exceeded the certain statistical delay threshold. The gNB may send the determined information to the UE.

In certain aspects, the event may correspond to detecting values exceeding one or more thresholds of the fourth set of thresholds associated with the energy status report. For example, the UE may determine that the values associated with the one or more features of the energy status report may have exceeded a certain energy threshold of the fourth set of thresholds. In another example, the gNB may determine that the values associated with the one or more features of the energy status report may have exceeded the certain energy threshold. The gNB may send the determined information to the UE.

In certain aspects, the UE or the gNB may autonomously switch an SSSG, based on content of one or more reports such as the delay status report (which may also include the statistical delay report). For example, the UE may transmit these reports to the gNB, so both the UE and the gNB know the content of these reports and hence can switch the SSSG based on a certain threshold. In some cases, different tables for different thresholds on different quantities of the reports can be used to trigger different SSSG states.

In certain aspects, the event may correspond to detecting an increase or a decrease of a scheduling request (SR) rate within a defined time period. For example, the UE or the gNB may autonomously switch the SSSG based on any increase or decrease of a current SR use with respect to a configured or prior SR rate.

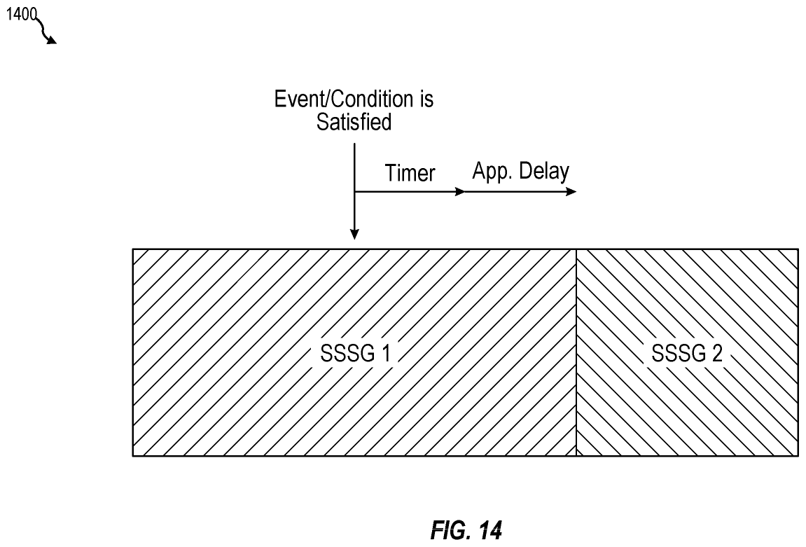

As illustrated in a diagram 1400 of FIG. 14, the gNB may define a parameter X to configure a number of SR occasions within a window Y (e.g., in time units or SR occasions) where X and Y are layer 1, layer 2, or layer 3 configured parameters. In this example, the gNB may configure the UE that if the SR rate is 60% or more within the window Y, the UE can switch to another SSSG after T time units.

Referring back to FIG. 13, the event may correspond to detecting an increase or a decrease of an uplink data rate within a defined time period. For example, the UE or the gNB may autonomously switch the SSSG based on any increase or decrease of an arrival rate or a number of physical uplink shared channel (PUSCH) transmissions within a period with respect to a configured or prior uplink data rate.

In certain aspects, the event may correspond to detecting a change in a traffic periodicity. For example, the UE or the gNB may autonomously switch the SSSG based on the change in the traffic periodicity from X (e.g., 60 frames per second) to Y (e.g., 30 frames per second) for XR or other traffic.

In certain aspects, the event may correspond to detecting a change in a packet delay budget. For example, the UE or the gNB may autonomously switch the SSSG based on the change in a quality of service (QOS) requirement such as the packet delay budget from X (e.g., 10 milliseconds) to Y (e.g., 30 milliseconds).

In certain aspects, the event may correspond to determining presence of one or more types of traffic. For example, the UE or the gNB may autonomously switch the SSSG based on detection of certain traffic such as ultra-reliable low latency communication (URLLC) traffic, XR traffic, etc.

In certain aspects, the event may correspond to transmitting an uplink cancellation indication of a number of resources or occasions. For example, the UE or the gNB may autonomously switch the SSSG when the UE may send the uplink cancellation indication of a certain ((pre) configured) number of resources or occasions (include one resource case).

In certain aspects, the event may correspond to detecting that one or more delay parameters associated with the delay status report and/or the statistical delay report are approaching an expiry threshold.

In certain aspects, the event may correspond to detecting an increase or a decrease in a number of hybrid automatic repeat request (HARQ) transmissions. Each HARQ transmission indicates a positive acknowledgement feedback or a negative acknowledgement feedback. For example, the UE or the gNB may autonomously switch the SSSG based on any increase in a defined NACK rate. In some cases, the gNB may define a parameter Z to configure a number of HARQ-ACK occasions within a window of L, where both Z and L are layer 1, layer 2, or layer 3 configured parameters.

In certain aspects, the event may correspond to detecting an increase or a decrease of a downlink data rate within a defined time period. For example, the UE or the gNB may autonomously switch the SSSG based on any increase or decrease of a number of received/transmitted data/PDSCH packets from the gNB within a period of time with respect to a configured number.

In certain aspects, the event may correspond to detecting an increase or a decrease of a charging rate of the UE. For example, the UE or the gNB may autonomously switch the SSSG based on a change of the charging rate from X charging rate to Y charging rate. In some cases, the UE may send the energy status report in standalone signals or multiplexing with layer 1, layer 2, or layer 3 signals to the UE, and the energy status report may be used for aligning the knowledge at the UE and the gNB about energy profile or status at the UE.

In certain aspects, the event may correspond to detecting an increase or a decrease of a discharging rate of the UE. For example, the UE or the gNB may autonomously switch the SSSG based on a change of the discharging rate from X discharging rate to Y discharging rate.

In certain aspects, the event may correspond to detecting an increase or a decrease of an energy level of the UE. For example, the UE or the gNB may autonomously switch the SSSG based on a change of the energy level from X energy level to Y energy level.

In certain aspects, the event may correspond to an increase or a decrease of a number of retransmissions received by the UE. For example, the UE or the gNB may autonomously switch the SSSG based on a certain rate or counter of number of retransmissions during a configured window.

In certain aspects, the event may correspond to detecting activation of one or more component carriers (CCs). For example, the UE or the gNB may autonomously switch the SSSG based on the activation of a certain number of CCs.

In certain aspects, the event may correspond to detecting deactivation of the one or more CCs. For example, the UE or the gNB may autonomously switch the SSSG based on the deactivation of a certain number of CCs.

In certain aspects, the event may correspond to detecting that the one or more CCs are in a dormancy state. For example, the UE or the gNB may autonomously switch the SSSG based on putting a certain number of CCs in the dormancy state.

In certain aspects, the event may correspond to receiving one or more PDCCHs skipping at one or more CCs. For example, the UE or the gNB may autonomously switch the SSSG based on receiving the one or more PDCCHs at the one or more CCs.

In certain aspects, the event may correspond to determining that a number of bits across one or more logical channel groups (LCGs) exceeds a threshold. For example, based on certain reports (such as the buffer status report) and the number of bits across all LCGs (or a subset of LCGs configured by the gNB), the UE and the gNB may determine to switch to a new SSSG after a certain time Y and/or until the gNB may send a DCI indicating to switch and when to switch to the UE. In some cases, the gNB may configure which reports and LCGs are part of a decision to determine to switch to the new SSSG. In some cases, there may be multiple thresholds or conditions associated with the reports and the LCGs that can be used to determine to switch to a different SSSG.

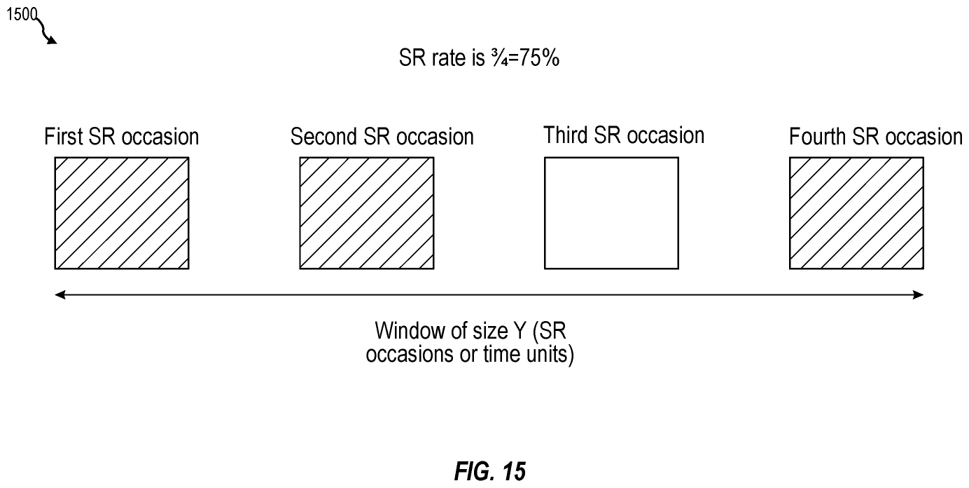

In certain aspects, the UE may switch from the first SSSG to the second SSSG, after a certain time period, from the occurrence of the event. In one example, the time period may indicate an expiration of a timer for determining when to switch from the first SSSG to the second SSSG. In another example, the time period may indicate a number of PDCCHs monitoring occasions based on the first SSSG. As illustrated in a diagram 1500 of FIG. 15, the UE or the gNB switches from SSSG 1 to SSSG2 after a certain time (e.g., based on the timer) and an application delay.

In certain aspects, the UE may switch from the first SSSG to the second SSSG, after a receipt of a DCI from the gNB, from the occurrence of the event. The DCI indicates to switch from the first SSSG to the second SSSG. For example, the gNB may send an actual switch DCI when the gNB can (although some systems may already use the timer to switch between a current SSSG to another SSSG, so the gNB indication is not always in use to decide to switch the SSSG). If the gNB does not send the DCI indication, the UE and the gNB may switch back to another SSSG after a certain timer.

In certain aspects, the UE may skip monitoring of one or more PDCCHs in one or more SSSs associated with one or more SSSGs based on information associated with the energy status report. For example, the UE may firstly obtain/process this information associated with the energy status report and then determine a duration for the skipping of the monitoring of the one or more PDCCHs and a type of the one or more PDCCHs to be skipped for the monitoring based on content of the energy status report. In some cases, a skip duration and which control signals/PDCCHs can be (pre) configured using layer 1, layer 2, or layer 3 are based on some conditions set for the event.

In certain aspects, the UE may skip monitoring of the one or more PDCCHs in one or more SSSs associated with one or more SSSGs based on information associated with the delay status report. For example, the UE may firstly obtain/process this information associated with the delay status report (e.g., a delay profile, i.e., delay is expired of current packets), and then determine a duration for the skipping of the monitoring of the one or more PDCCHs and a type of the one or more PDCCHs to be skipped for the monitoring based on content of the delay status report.

In certain aspects, the UE may skip monitoring of the one or more PDCCHs in one or more SSSs associated with one or more SSSGs based on information associated with the statistical delay report. For example, the UE may firstly obtain/process this information associated with the statistical status report and then determine a duration for the skipping of the monitoring of the one or more PDCCHs and a type of the one or more PDCCHs to be skipped for the monitoring based on content of the statistical status report.

In certain aspects, the UE may skip monitoring of the one or more PDCCHs in one or more SSSs associated with one or more SSSGs based on energy harvesting information. For example, the UE may firstly obtain/process the energy harvesting information (e.g., such as energy harvesting profile indicating different times of energy harvesting), and then determine a duration for the skipping of the monitoring of the one or more PDCCHs and a type of the one or more PDCCHs to be skipped for the monitoring based on content of the statistical status report.

In certain aspects, the UE may skip monitoring of the one or more PDCCHs which may be associated with (or used for) scheduling uplink data (i.e., skip monitoring of uplink data scheduling DCI),

In certain aspects, the UE may skip monitoring of the one or more PDCCHs which may be associated with scheduling downlink data (i.e., skip monitoring of downlink data scheduling DCI).

In certain aspects, the UE may skip monitoring of the one or more PDCCHs which may be associated with scheduling harvesting of wireless energy (e.g., skip Energy scheduling DCI). In some cases, the UE may not need or use wireless (e.g., radio frequency/laser) energy harvesting, and hence it can skip DCIs used for this purpose.

In certain aspects, the UE may skip monitoring of the one or more PDCCHs which may be associated with configuring a duration for the harvesting of the wireless energy (e.g., skip energy harvesting duration configuring DCI). In some cases, the UE may not need energy, and hence it can skip DCIs used for this purpose.

In certain aspects, the UE may skip monitoring of the one or more PDCCHs which may be associated with a PDCCH order to initiate a random access channel (RACH) procedure (i.e., PDCCH order DCI).

### Example Method for Wireless Communications at a User Equipment (UE)

FIG. 16 shows an example of a method 1600 for wireless communications at a user equipment (UE), such as the UE 104 of FIG. 1 and FIG. 3.

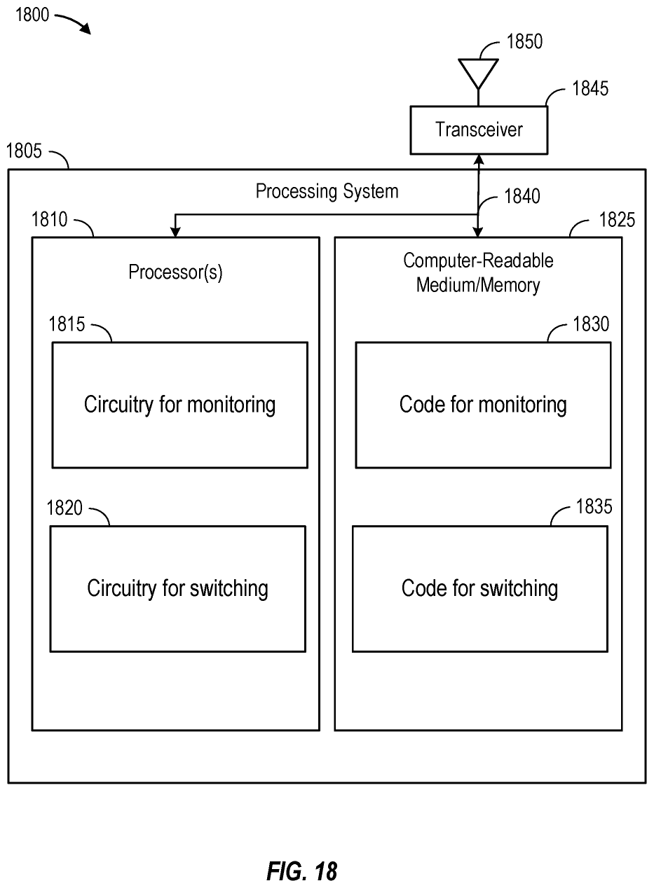

Method 1600 begins at step 1610 with monitoring search space sets (SSSs) associated with a first SSS group (SSSG) for at least one control channel. In some cases, the operations of this step refer to, or may be performed by, circuitry for monitoring and/or code for monitoring as described with reference to FIG. 18.

Method 1600 then proceeds to step 1620 with switching from the first SSSG to a second SSSG based on an occurrence of an event. In some cases, the operations of this step refer to, or may be performed by, circuitry for switching and/or code for switching as described with reference to FIG. 18.

Method 1600 then proceeds to step 1630 with monitoring SSSs associated with a second SSSG for the at least one control channel. In some cases, the operations of this step refer to, or may be performed by, circuitry for monitoring and/or code for monitoring as described with reference to FIG. 18.

In certain aspects, the method 1600 further includes receiving a configuration of a plurality of SSSGs comprising at least the first SSSG and the second SSSG.

In certain aspects, the event corresponds to detecting values exceeding one or more thresholds associated with at least one of a buffer status report comprising information corresponding to an amount of data available for transmission in an uplink buffer of the UE; a delay status report comprising information corresponding to at least one of: a remaining packet delay budget or a packet wait time; a statistical delay report; or an energy status report comprising information corresponding to at least one of an energy level profile of the UE, a charging rate of the UE, or a discharging rate of the UE.

In certain aspects, the method 1600 further includes receiving a configuration indicating the one or more thresholds.

In certain aspects, the method 1600 further includes receiving a configuration indicating different thresholds for different reports comprising the buffer status report, the delay status report, the statistical delay report, and the energy status report.

In certain aspects, the event corresponds to detecting an increase or a decrease of a scheduling request (SR) rate within a defined time period.

In certain aspects, the event corresponds to detecting an increase or a decrease of an uplink data rate within a defined time period.

In certain aspects, the event corresponds to detecting a change in at least one of a traffic periodicity or a packet delay budget.

In certain aspects, the event corresponds to determining presence of one or more types of traffic comprising at least one of ultra-reliable low latency communication (URLLC) traffic or extended reality (XR) traffic.

In certain aspects, the event corresponds to transmitting an uplink cancellation indication of a number of resources or occasions.

In certain aspects, the event corresponds to detecting that one or more delay parameters associated with at least one of a delay status report or a statistical delay report are approaching an expiry threshold.

In certain aspects, the event corresponds to detecting an increase or a decrease in a number of hybrid automatic repeat request (HARQ) transmissions, and each HARQ transmission indicates a positive acknowledgement feedback or a negative acknowledgement feedback.

In certain aspects, the event corresponds to detecting an increase or a decrease of a downlink data rate within a defined time period.

In certain aspects, the event corresponds to detecting an increase or a decrease of at least one of a charging rate of the UE, a discharging rate of the UE, or an energy level of the UE.

In certain aspects, the event corresponds to detecting an increase or a decrease of a number of retransmissions received by the UE.

In certain aspects, the event corresponds to at least one of detecting activation of one or more component carriers (CCs), and the method 1600 further includes detecting deactivation of the one or more CCs or detecting that the one or more CCs are in a dormancy state.

In certain aspects, the event corresponds to receiving one or more physical downlink control channels (PDCCHs) skipping at one or more CCs.

In certain aspects, the event corresponds to determining that a number of bits across one or more logical channel groups (LCGs) exceeds a threshold, and the method 1600 further includes receiving a configuration indicating the one or more LCGs.

In certain aspects, the switching includes switching from the first SSSG to the second SSSG, after at least one of a certain time period or a receipt of a downlink control information (DCI) indicating to switch from the first SSSG to the second SSSG, from the occurrence of the event.

In certain aspects, the time period indicates at least one of an expiration of a timer for determining when to switch from the first SSSG to the second SSSG, or a number of PDCCHs monitoring occasions based on the first SSSG.

In certain aspects, the method 1600 further includes skipping monitoring of one or more PDCCHs in one or more SSSs associated with one or more SSSGs based on at least one of information associated with an energy status report, information associated with a delay status report, information associated with a statistical delay report, or energy harvesting information.

In certain aspects, the method 1600 further includes determining a duration for the skipping of the monitoring of the one or more PDCCHs and a type of the one or more PDCCHs to be skipped for the monitoring, based on at least one of the information associated with the energy status report, the information associated with the delay status report, the information associated with the statistical delay report, or the energy harvesting information.

In certain aspects, the one or more PDCCHs are associated with at least one of scheduling uplink data, scheduling downlink data, scheduling harvesting of wireless energy, configuring a duration for the harvesting of the wireless energy, or a PDCCH order to initiate a random access channel (RACH) procedure.

In one aspect, the method 1600, or any aspect related to it, may be performed by an apparatus, such as a communications device 1800 of FIG. 18, which includes various components operable, configured, or adapted to perform the method 1600. The communications device 1800 is described below in further detail.

Note that FIG. 16 is just one example of a method, and other methods including fewer, additional, or alternative steps are possible consistent with this disclosure.

### Example Method for Wireless Communications at a Network Entity

FIG. 17 shows an example of a method 1700 for wireless communications at a network entity, such as the BS 102 of FIG. 1 and FIG. 3.

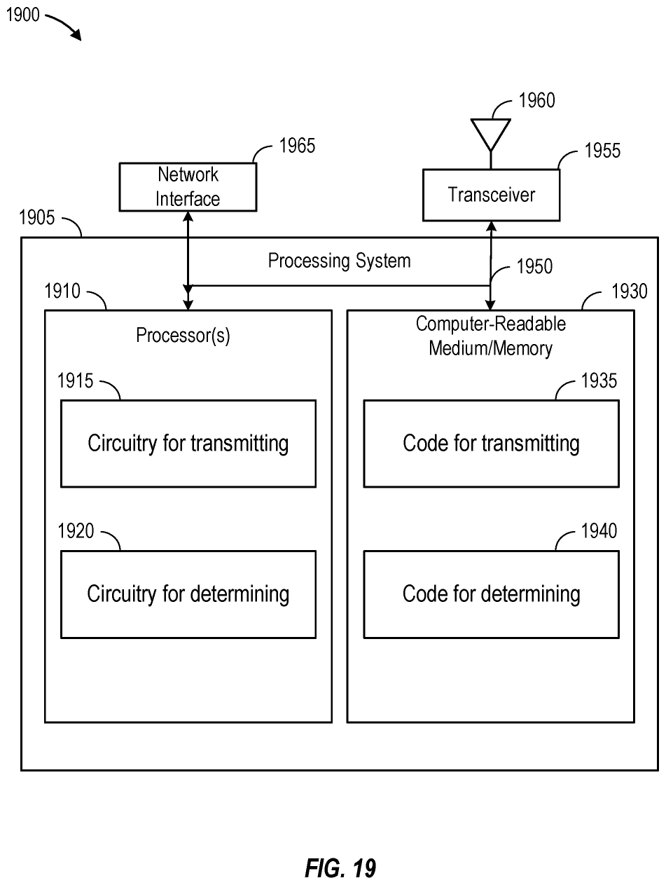

Method 1700 begins at step 1710 with transmitting a configuration of a plurality of search space set groups (SSSGs) including at least a first SSSG and a second SSSG to a user equipment (UE). In some cases, the operations of this step refer to, or may be performed by, circuitry for transmitting and/or code for transmitting as described with reference to FIG. 19.

Method 1700 then proceeds to step 1720 with determining to switch control channel monitoring of the UE from the first SSSG to the second SSSG based on an occurrence of an event. In some cases, the operations of this step refer to, or may be performed by, circuitry for determining and/or code for determining as described with reference to FIG. 19.

Method 1700 then proceeds to step 1730 with transmitting an indication to the UE to switch from the first SSSG to the second SSSG, in accordance with the determination. In some cases, the operations of this step refer to, or may be performed by, circuitry for transmitting and/or code for transmitting as described with reference to FIG. 19.

In certain aspects, the event corresponds to detecting an increase or a decrease of a scheduling request (SR) rate within a defined time period.

In certain aspects, the event corresponds to detecting an increase or a decrease of an uplink data rate within a defined time period.

In one aspect, the method 1700, or any aspect related to it, may be performed by an apparatus, such as a communications device 1900 of FIG. 19, which includes various components operable, configured, or adapted to perform the method 1700. The communications device 1900 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment (UE), such as UE 104 described above with respect to FIG. 1 and FIG. 3.

The communications device 1800 includes a processing system 1805 coupled to a transceiver 1345 (e.g., a transmitter and/or a receiver). The transceiver 1845 is configured to transmit and receive signals for the communications device 1800 via an antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, cause the one or more processors 1810 to perform the method 1600 described with respect to FIG. 16, and/or any aspect related to it. Note that reference to a processor performing a function of communications device 1800 may include the one or more processors 1810 performing that function of communications device 1800.

In the depicted example, at least one computer-readable medium/memory 1825 stores code (e.g., executable instructions), such as code for monitoring 1830 and code for switching 1835. Processing of the code for monitoring 1830 and the code for switching 1835 may cause the communications device 1800 to perform the method 1600 described with respect to FIG. 16, and/or any aspect related to it.

The one or more processors 1810 (individually or collectively) include circuitry configured to implement (e.g., execute) the code stored in the computer-readable medium/memory 1825, including circuitry such as circuitry for monitoring 1815 and circuitry for switching 1820. Processing with the circuitry for monitoring 1815 and the circuitry for switching 1820 may cause the communications device 1800 to perform the method 1600 described with respect to FIG. 16, and/or any aspect related to it.

Various components of the communications device 1800 may provide means for performing the method 1600 described with respect to FIG. 16, and/or any aspect related to it. For example, means for transmitting, sending or outputting for transmission may include transceivers 354 and/or antenna(s) 352 of the UE 104 illustrated in FIG. 3 and/or the transceiver 1845 and the antenna 1850 of the communications device 1800 in FIG. 13. Means for receiving or obtaining may include transceivers 354 and/or antenna(s) 352 of the UE 104 illustrated in FIG. 3 and/or the transceiver 1845 and the antenna 1850 of the communications device 1800 in FIG. 18. Means for monitoring may include processors, transceivers 354 and/or antenna(s) 352 of the UE 104 illustrated in FIG. 3 and/or the code for monitoring 1830, the circuitry for monitoring 1815, the transceiver 1845 and the antenna 1850 of the communications device 1800 in FIG. 18. Means for switching may include processors, transceivers 354 and/or antenna(s) 352 of the UE 104 illustrated in FIG. 3 and/or the code for switching 1835, the circuitry for switching 1820, the transceiver 1845 and the antenna 1850 of the communications device 1800 in FIG. 18.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 18 is an example, and many other examples and configurations of communication device 1800 are possible.

FIG. 19 depicts aspects of an example communications device 1900. In some aspects, communications device 1900 is a network entity, such as BS 102 of FIG. 1 and FIG. 3, or a disaggregated base station as discussed with respect to FIG. 2.

The communications device 1900 includes a processing system 1905 coupled to a transceiver 1955 (e.g., a transmitter and/or a receiver) and/or a network interface 1965. The transceiver 1955 is configured to transmit and receive signals for the communications device 1900 via an antenna 1960, such as the various signals as described herein. The network interface 1965 is configured to obtain and send signals for the communications device 1900 via communication link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to at least one computer-readable medium/memory 1930 via a bus 1950. In certain aspects, the computer-readable medium/memory 1930 is configured to store instructions (e.g., computer-executable code) that when executed by the one or more processors 1910, cause the one or more processors 1910 to perform the method 1700 described with respect to FIG. 17, or any aspect related to it. Note that reference to a processor of communications device 1900 performing a function may include the one or more processors 1910 of communications device 1900 performing that function.

In the depicted example, the computer-readable medium/memory 1930 stores code (e.g., executable instructions), such as code for transmitting 1935 and code for determining 1940. Processing of the code for transmitting 1935 and the code for determining 1940 may cause the communications device 1900 to perform the method 1700 described with respect to FIG. 17, or any aspect related to it.

The one or more processors 1910 (individually or collectively) include circuitry configured to implement (e.g., execute) the code stored in the computer-readable medium/memory 1930, including circuitry such as circuitry for transmitting 1915 and circuitry for determining 1920. Processing with the circuitry for transmitting 1915 and the circuitry for determining 1920 may cause the communications device 1900 to perform the method 1700 described with respect to FIG. 17, or any aspect related to it.

Various components of the communications device 1900 may provide means for performing the method 1700 described with respect to FIG. 17, or any aspect related to it. Means for transmitting, sending or outputting for transmission may include transceivers 332 and/or antenna(s) 334 of the BS 102 illustrated in FIG. 3 and/or the circuitry for transmitting 1915, the code for transmitting 1935, the transceiver 1955 and the antenna 1960 of the communications device 1900 in FIG. 19. Means for receiving or obtaining may include transceivers 332 and/or antenna(s) 334 of the BS 102 illustrated in FIG. 3 and/or the transceiver 1955 and the antenna 1960 of the communications device 1900 in FIG. 19. Means for determining may include processors, transceivers 332 and/or antenna(s) 334 of the BS 102 illustrated in FIG. 3 and/or the code for determining 1940, the circuitry for determining 1920, the transceiver 1955 and the antenna 1960 of the communications device 1900 in FIG. 19.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 19 is an example, and many other examples and configurations of communication device 1900 are possible.

### Example Clauses

Implementation examples are described in the following numbered clauses:

Clause 1: A method for wireless communications at a user equipment (UE), comprising: monitoring search space sets (SSSs) associated with a first SSS group (SSSG) for at least one control channel; switching from the first SSSG to a second SSSG based on an occurrence of an event; and monitoring SSSs associated with a second SSSG for the at least one control channel.

Clause 2: The method of clause 1, further comprising receiving a configuration of a plurality of SSSGs comprising at least the first SSSG and the second SSSG.

Clause 3: The method of any one of clauses 1-2, wherein the event corresponds to detecting values exceeding one or more thresholds associated with at least one of: a buffer status report comprising information corresponding to an amount of data available for transmission in an uplink buffer of the UE; a delay status report comprising information corresponding to at least one of: a remaining packet delay budget or a packet wait time; a statistical delay report; or an energy status report comprising information corresponding to at least one of: an energy level profile of the UE, a charging rate of the UE, or a discharging rate of the UE.

Clause 4: The method of clause 3, further comprising receiving a configuration indicating the one or more thresholds.

Clause 5: The method of clause 3, further comprising receiving a configuration indicating different thresholds for different reports comprising the buffer status report, the delay status report, the statistical delay report, and the energy status report.

Clause 6: The method of any one of clauses 1-5, wherein the event corresponds to detecting an increase or a decrease of a scheduling request (SR) rate within a defined time period.

Clause 7: The method of any one of clauses 1-6, wherein the event corresponds to detecting an increase or a decrease of an uplink data rate within a defined time period.

Clause 8: The method of any one of clauses 1-7, wherein the event corresponds to detecting a change in at least one of: a traffic periodicity; or a packet delay budget.

Clause 9: The method of any one of clauses 1-8, wherein the event corresponds to determining presence of one or more types of traffic comprising at least one of: ultra-reliable low latency communication (URLLC) traffic; or extended reality (XR) traffic.

Clause 10: The method of any one of clauses 1-9, wherein the event corresponds to transmitting an uplink cancellation indication of a number of resources or occasions.

Clause 11: The method of any one of clauses 1-10, wherein the event corresponds to detecting that one or more delay parameters associated with at least one of: a delay status report or a statistical delay report are approaching an expiry threshold.

Clause 12: The method of any one of clauses 1-11, wherein the event corresponds to detecting an increase or a decrease in a number of hybrid automatic repeat request (HARQ) transmissions; and each HARQ transmission indicates a positive acknowledgement feedback or a negative acknowledgement feedback.

Clause 13: The method of any one of clauses 1-12, wherein the event corresponds to detecting an increase or a decrease of a downlink data rate within a defined time period.

Clause 14: The method of any one of clauses 1-13, wherein the event corresponds to detecting an increase or a decrease of at least one of: a charging rate of the UE; a discharging rate of the UE; or an energy level of the UE.

Clause 15: The method of any one of clauses 1-14, wherein the event corresponds to detecting an increase or a decrease of a number of retransmissions received by the UE.

Clause 16: The method of any one of clauses 1-15, wherein the event corresponds to at least one of detecting activation of one or more component carriers (CCs); detecting deactivation of the one or more CCs; or detecting that the one or more CCs are in a dormancy state.

Clause 17: The method of any one of clauses 1-16, wherein the event corresponds to receiving one or more physical downlink control channels (PDCCHs) skipping at one or more component carriers (CCs).

Clause 18: The method of clause 3, wherein the event corresponds to determining that a number of bits across one or more logical channel groups (LCGs) exceeds a threshold; and receiving a configuration indicating the one or more LCGs.

Clause 19: The method of any one of clauses 1-18, wherein the switching comprises switching from the first SSSG to the second SSSG, after at least one of: a certain time period or a receipt of a downlink control information (DCI) indicating to switch from the first SSSG to the second SSSG, from the occurrence of the event.

Clause 20: The method of clause 19, wherein the time period indicates at least one of an expiration of a timer for determining when to switch from the first SSSG to the second SSSG; or a number of physical downlink control channels (PDCCHs) monitoring occasions based on the first SSSG.

Clause 21: The method of any one of clauses 1-20, further comprising skipping monitoring of one or more physical downlink control channels (PDCCHs) in one or more SSSs associated with one or more SSSGs based on at least one of information associated with an energy status report; information associated with a delay status report; information associated with a statistical delay report; or energy harvesting information.

Clause 22: The method of clause 21, further comprising determining a duration for the skipping of the monitoring of the one or more PDCCHs and a type of the one or more PDCCHs to be skipped for the monitoring, based on at least one of the information associated with the energy status report; the information associated with the delay status report; the information associated with the statistical delay report; or the energy harvesting information.

Clause 23: The method of clause 21, wherein the one or more PDCCHs are associated with at least one of scheduling uplink data; scheduling downlink data; scheduling harvesting of wireless energy; configuring a duration for the harvesting of the wireless energy; or a PDCCH order to initiate a random access channel (RACH) procedure.

Clause 24: A method for wireless communications at a network entity, comprising: transmitting a configuration of a plurality of search space set groups (SSSGs) comprising at least a first SSSG and a second SSSG to a user equipment (UE); determining to switch control channel monitoring of the UE from the first SSSG to the second SSSG based on an occurrence of an event; and transmitting an indication to the UE to switch from the first SSSG to the second SSSG, in accordance with the determination.

Clause 25: The method of clause 24, wherein the event corresponds to detecting an increase or a decrease of a scheduling request (SR) rate within a defined time period.

Clause 26: The method of any one of clauses 24-25, wherein the event corresponds to detecting an increase or a decrease of an uplink data rate within a defined time period.

Clause 27: An apparatus, comprising: at least one memory comprising instructions; and one or more processors configured, individually or collectively, to execute the instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by one or more processors of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors configured, individually or collectively, to execute the instructions and cause the apparatus to:
monitor search space sets (SSSs) associated with a first SSS group (SSSG) for at least one control channel;
switch from the first SSSG to a second SSSG based on an occurrence of an event; and
monitor SSSs associated with a second SSSG for the at least one control channel.

2. The apparatus of claim 1, wherein the one or more processors are configured, individually or collectively, to execute the instructions and cause the apparatus to receive a configuration of a plurality of SSSGs comprising at least the first SSSG and the second SSSG.

3. The apparatus of claim 1, wherein the event corresponds to detecting values exceeding one or more thresholds associated with at least one of:
a buffer status report comprising information corresponding to an amount of data available for transmission in an uplink buffer of the UE;
a delay status report comprising information corresponding to at least one of: a remaining packet delay budget or a packet wait time;
a statistical delay report; or
an energy status report comprising information corresponding to at least one of: an energy level profile of the UE, a charging rate of the UE, or a discharging rate of the UE.

4. The apparatus of claim 3, wherein the one or more processors are configured, individually or collectively, to execute the instructions and cause the apparatus to receive a configuration indicating the one or more thresholds.

5. The apparatus of claim 3, wherein the one or more processors are configured, individually or collectively, to execute the instructions and cause the apparatus to receive a configuration indicating different thresholds for different reports comprising the buffer status report, the delay status report, the statistical delay report, and the energy status report.

6. The apparatus of claim 1, wherein the event corresponds to detecting an increase or a decrease of a scheduling request (SR) rate within a defined time period.

7. The apparatus of claim 1, wherein the event corresponds to detecting an increase or a decrease of an uplink data rate within a defined time period.

8. The apparatus of claim 1, wherein the event corresponds to detecting a change in at least one of:
a traffic periodicity; or
a packet delay budget.

9. The apparatus of claim 1, wherein the event corresponds to determining presence of one or more types of traffic comprising at least one of:
ultra-reliable low latency communication (URLLC) traffic; or
extended reality (XR) traffic.

10. The apparatus of claim 1, wherein the event corresponds to transmitting an uplink cancellation indication of a number of resources or occasions.

11. The apparatus of claim 1, wherein the event corresponds to detecting that one or more delay parameters associated with at least one of: a delay status report or a statistical delay report are approaching an expiry threshold.

12. The apparatus of claim 1, wherein:
the event corresponds to detecting an increase or a decrease in a number of hybrid automatic repeat request (HARQ) transmissions; and
each HARQ transmission indicates a positive acknowledgement feedback or a negative acknowledgement feedback.

13. The apparatus of claim 1, wherein the event corresponds to detecting an increase or a decrease of a downlink data rate within a defined time period.

14. The apparatus of claim 1, wherein the event corresponds to detecting an increase or a decrease of at least one of:
a charging rate of the UE;
a discharging rate of the UE; or
an energy level of the UE.

15. The apparatus of claim 1, wherein the event corresponds to detecting an increase or a decrease of a number of retransmissions received by the UE.

16. The apparatus of claim 1, wherein the event corresponds to at least one of:
detecting activation of one or more component carriers (CCs);
detecting deactivation of the one or more CCs; or
detecting that the one or more CCs are in a dormancy state.

17. The apparatus of claim 1, wherein the event corresponds to receiving one or more physical downlink control channels (PDCCHs) skipping at one or more component carriers (CCs).

18. The apparatus of claim 3, wherein:
the event corresponds to determining that a number of bits across one or more logical channel groups (LCGs) exceeds a threshold; and
receiving a configuration indicating the one or more LCGs.

19. The apparatus of claim 1, wherein the one or more processors are configured, individually or collectively, to execute the instructions and cause the apparatus to switch from the first SSSG to the second SSSG, after at least one of: a certain time period or a receipt of a downlink control information (DCI) indicating to switch from the first SSSG to the second SSSG, from the occurrence of the event.

20. The apparatus of claim 19, wherein the time period indicates at least one of:
an expiration of a timer for determining when to switch from the first SSSG to the second SSSG; or
a number of physical downlink control channels (PDCCHs) monitoring occasions based on the first SSSG.

21. The apparatus of claim 1, wherein the one or more processors are configured, individually or collectively, to execute the instructions and cause the apparatus to skip monitoring of one or more physical downlink control channels (PDCCHs) in one or more SSSs associated with one or more SSSGs based on at least one of:
information associated with an energy status report;
information associated with a delay status report;
information associated with a statistical delay report; or
energy harvesting information.

22. The apparatus of claim 21, wherein the one or more processors are configured, individually or collectively, to execute the instructions and cause the apparatus to determine a duration for the skipping of the monitoring of the one or more PDCCHs and a type of the one or more PDCCHs to be skipped for the monitoring, based on at least one of:
the information associated with the energy status report;
the information associated with the delay status report;
the information associated with the statistical delay report; or
the energy harvesting information.

23. The apparatus of claim 21, wherein the one or more PDCCHs are associated with at least one of:
scheduling uplink data;
scheduling downlink data;
scheduling harvesting of wireless energy;
configuring a duration for the harvesting of the wireless energy; or
a PDCCH order to initiate a random access channel (RACH) procedure.

24. An apparatus for wireless communications at a network entity, comprising:
at least one memory comprising instructions; and
one or more processors configured, individually or collectively, to execute the instructions and cause the apparatus to:
transmit a configuration of a plurality of search space set groups (SSSGs) comprising at least a first SSSG and a second SSSG to a user equipment (UE);
determine to switch control channel monitoring of the UE from the first SSSG to the second SSSG based on an occurrence of an event; and
transmit an indication to the UE to switch from the first SSSG to the second SSSG, in accordance with the determination.

25. The apparatus of claim 24, wherein the event corresponds to detecting an increase or a decrease of a scheduling request (SR) rate within a defined time period.

26. The apparatus of claim 24, wherein the event corresponds to detecting an increase or a decrease of an uplink data rate within a defined time period.

27. A method for wireless communications at a user equipment (UE), comprising:
monitoring search space sets (SSSs) associated with a first SSS group (SSSG) for at least one control channel;
switching from the first SSSG to a second SSSG based on an occurrence of an event; and
monitoring SSSs associated with a second SSSG for the at least one control channel.

28. The method of claim 27, further comprising receiving a configuration of a plurality of SSSGs comprising at least the first SSSG and the second SSSG.

29. A method for wireless communications at a network entity, comprising:
transmitting a configuration of a plurality of search space set groups (SSSGs) comprising at least a first SSSG and a second SSSG to a user equipment (UE);
determining to switch control channel monitoring of the UE from the first SSSG to the second SSSG based on an occurrence of an event; and
transmitting an indication to the UE to switch from the first SSSG to the second SSSG, in accordance with the determination.

30. The method of claim 29, wherein the event corresponds to detecting an increase or a decrease of a scheduling request (SR) rate within a defined time period.
